(19) United States
(12) Patent Application Publication
(10) Pub. No.: US 2014/0246359 A1
(43) Pub. Date: Sep. 4, 2014

(54) Magnetic Drum Separator with an Outer Shell Having Traction Elements

(71) Applicants: Xinkai Jiang, Fairview, PA (US); Timothy G. Shuttleworth, Girard, PA (US)

(72) Inventors: Xinkai Jiang, Fairview, PA (US); Timothy G. Shuttleworth, Girard, PA (US)

(73) Assignee: Eriez Manufacturing Co., Erie, PA (US)

(21) Appl. No.: 13/782,414

(22) Filed: Mar. 1, 2013

(51) Int. Cl. B03C 1/247

(52) U.S. Cl. CPC B03C 1/247
USPC 209/213

(57) ABSTRACT

A magnetic drum separator for the separation of ferrous and non-ferrous materials from a material stream that comprises an outer shell that is rotatable by a drive mechanism. The outer shell has a tubular length, a circular cross-section, a traction plate is joined to the outer shell, the traction plate has a traction element. In another embodiment the outer shell has a tubular length, a circular cross-section, and a integral traction element. The traction elements could be a series of negative indentations, raised bumps, perforations, serrated teeth, protruding ridges, segmented protruding ridges, minor cleats, or segmented minor cleats.

This application takes priority from U.S. provisional application No. 61/605,996 filed Mar. 2, 2012, which is incorporated herein by reference.

### BACKGROUND

Magnetic drum separators are used to sort shredded scrap material streams that comprise various combinations of ferrous material and non-ferrous materials (including non-metals, sometimes known as organic material or fluff, and non-magnetic metals) by extracting the ferrous material from the material stream. Sometimes during this sorting process non-ferrous materials will get stuck to or bound up with the ferrous material while in the material stream and remain with the ferrous material, even after the magnetic drum separator has tried to separate the material stream. This reduces the efficiency of downstream process and subsequently creates a negative economic impact on the resale value of the ferrous material. Ultimately, such a negative economic impact may actually reduce the overall value of the entire plant sorting ferrous and non-ferrous materials. What is presented are devices for agitating the sorted non-ferrous materials to reduce entrapment (i.e. the amount of non-ferrous scrap bound up with the ferrous material) after sorting.

### SUMMARY

What is claimed is a magnetic drum separator for the separation of ferrous and non-ferrous materials from a material stream comprising an outer shell that is rotatable by a drive mechanism. The outer shell has a tubular length and a circular cross-section. A traction plate that has a traction element is joined to the outer shell. The magnetic drum separator could comprise a standard cleat joined to the outer shell. The traction plates could be made from stainless steel, manganese steel, or other materials. The traction plate could be sized to fit the tubular length of the outer shell or be releasably joined to the outer shell. The traction element could be a minor cleat. The magnetic drum separator could further comprise at least two traction plates with one of the traction plates having a traction element that is a minor cleat and the other traction plate a different traction element. The traction element could be configured in many ways, including a series of negative indentations, raised bumps, perforations, serrated teeth, protruding ridges, segmented protruding ridges, minor cleats, or segmented minor cleats.

In another embodiment, a magnetic drum separator comprises an outer shell that is rotatable by a drive mechanism. The outer shell has a tubular length, a circular cross-section, and an integral traction element. This outer shell of this magnetic drum separator embodiment could be made from stainless steel or manganese steel. In some embodiments, the traction elements span across the tubular length of the outer shell. Some magnetic drum separator embodiments could have a standard cleat joined to the outer shell. This magnetic drum separator embodiment could comprise an integral traction element that is a minor cleat. The magnetic drum separator could have traction plates having their own traction elements in combination with the integral traction elements on the outer shell. The integral traction element in this embodiment could be a series of negative indentations, raised bumps, perforations, serrated teeth, protruding ridges, segmented protruding ridges, minor cleats, or segmented minor cleats.

In another embodiment, a magnetic drum separator comprises an outer shell that is rotatable by a drive mechanism. The outer shell has a tubular length, a circular cross-section, and a traction means for causing the material stream to tumble on the outer shell and to separate the ferrous material from the non-ferrous material. This magnetic drum separator embodiment could also comprise the outer shell having a standard cleat joined to it.

### BRIEF DESCRIPTION OF DRAWINGS

For a more complete understanding and appreciation of this invention, and its many advantages, reference will be made to the following detailed description taken in conjunction with the accompanying drawings.

FIG. 1 shows a prior art magnetic drum separator in operation;

FIG. 2 shows a perspective view of the prior art drum separator of FIG. 1;

FIG. 3 shows a perspective view of the drum separator having a plurality of traction plates joined around the surface of the outer shell;

FIG. 4 shows a perspective view of the drum separator having a plurality of traction plates joined around the surface of the outer shell that are shorter than the tubular length of the outer shell;

FIG. 5 shows a perspective view of the drum separator having a plurality of integral traction elements around the surface of the outer shell;

FIG. 6 shows a perspective view of the drum separator having a plurality of integral traction elements covering a portion of the surface that is shorter than the tubular length of the outer shell;

FIG. 7 shows a magnetic drum separator having a reversed rotation operation;

FIG. 8 shows a perspective view of the drum separator of FIG. 7 and having a plurality of traction plates joined around the surface of the outer shell;

FIG. 9 shows a perspective view of the drum separator of FIG. 7 and having a plurality of integral traction elements around the surface of the outer shell;

FIG. 10 shows a magnetic drum separator having multiple standard cleats and multiple minor cleats in operation;

FIG. 11 shows a perspective view of the drum separator of FIG. 10;

FIG. 12 shows a magnetic drum separator having a single standard cleat and multiple minor cleats in operation;

FIG. 13 shows a perspective view of the drum separator of FIG. 10 and having a plurality of traction plates having minor cleats as the traction elements joined around the surface of the outer shell;

FIG. 14 shows a perspective view of the drum separator of FIG. 10 and having a plurality of traction plates joined around the surface of the outer shell;

FIG. 15 shows a perspective view of the drum separator of FIG. 10 and having a plurality of integral traction elements around the surface of the outer shell;

FIG. 16A shows a perspective view of an embodiment of the traction element having a series of perforations along the surface of the traction element;

FIG. 16B shows a perspective view of an embodiment of the traction element having a series of raised bumps along the surface of the traction element;

FIG. 16C shows a perspective view of an embodiment of the traction element having a series of negative indentations along the surface of the traction element;

FIG. 16D shows a perspective view of an embodiment of the traction element having a series of protruding ridges along the surface of the traction element;

FIG. 16E shows a perspective view of an embodiment of the traction element having a series of serrated teeth along the surface of the traction element;

FIG. 16F shows a perspective view of an embodiment of the traction element having a series of segmented protruding ridges along the surface of the traction element;

FIG. 16G shows a perspective view of an embodiment of the traction element having minor cleats along the surface of the traction element;

FIG. 16H shows a perspective view of an embodiment of the traction element having segmented minor cleats along the surface of the traction element.

FIG. 17A shows a perspective view of an embodiment of the traction element having a series of segmented protruding ridges that are strategically arranged in an angled manner along the surface of the of the traction element;

FIG. 17B shows a perspective view of an embodiment of the traction element having minor cleats that are strategically arranged in an angled manner along the surface of the of the traction element; and

FIG. 17C shows a perspective view of an embodiment of the traction element having segmented minor cleats that are strategically arranged in an angled manner along the surface of the traction element.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

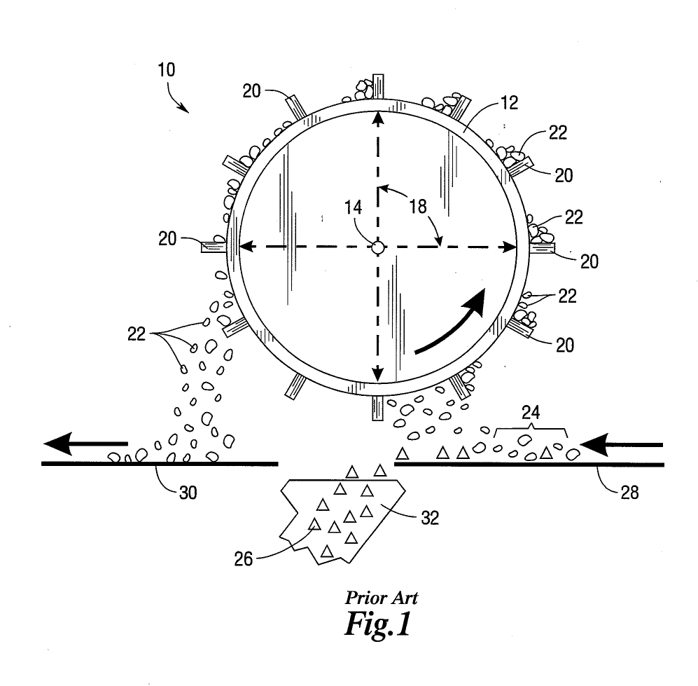

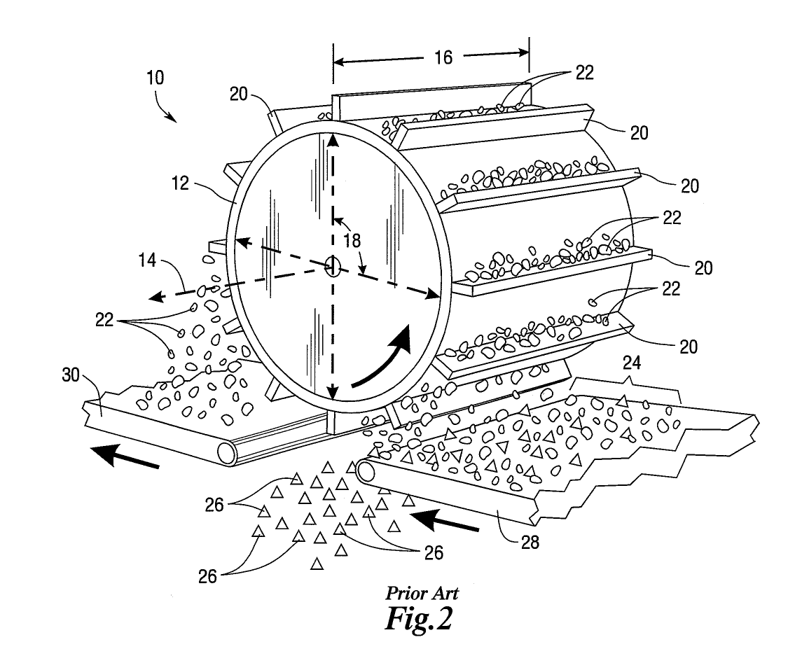

Magnetic drum separator systems typically process several hundred tons of raw materials a day and even several hundred tons per hour depending on the size of the facility and the size of the equipment being used. As shown in FIGS. 1 and 2, typical magnetic drum separators 10 consist of an outer shell 12 that is rotatable around a central axis 14 of rotation by a drive mechanism (not shown) in the direction indicated in the figures and around a number of parts (not shown) housed within the outer shell 12. The outer shell 12 has a tubular length 16 and a circular cross section 18. The outer shell 12 of the magnetic drum separator 10 could also comprise a series of standard cleats 20 that assist the movement of the ferrous 22 material on the outer shell 12 of the magnetic drum separator 10.

The material stream 24 to be sorted comprises a mixture of ferrous 22 material and non-ferrous 26 materials. The material stream 24 passes under the drum separator 10 using any appropriate first transfer system 28 such as conveyors, chutes, vibrators, etc. while the outer shell 12 rotates. The ferrous 22 material is magnetically attracted to the drum separator 10 and becomes magnetically attached to the surface of the outer shell 12. As the outer shell 12 rotates, the magnetically attached ferrous 22 material revolves around the central axis 14 of the magnetic drum separator 10 until the ferrous 22 material passes out of the magnetic field generated within the magnetic drum separator 10 and falls off the outer shell 12, on the far side of the material stream 24, and onto a second transfer system 30. The non-ferrous 26 materials of the material stream 24 that is not attracted to the outer shell 12 should fall off the first transfer system 28 into a chute 32 or other means for disposal or further processing.

In some instances, small scrap pieces of non-ferrous 26 materials, usually comprising non-magnetic metal including aluminum, copper, lead, etc. as well as other non-ferrous materials (otherwise known as “fluff” or “organic material”) including stones, cloth, plastic, glass, rubber, etc., will attach to the ferrous 22 material and unintentionally become magnetically attached to the outer shell 12 along with the ferrous 22 material. When these instances occur, the ferrous 22 material may separate from the non-ferrous 26 materials by shaking the non-ferrous 26 materials off when the ferrous 22 material tumbles on the outer shell 12 as the outer shell 12 rotates. However, ferrous 22 material tends to slide along the smooth surface of the outer circumference of the outer shell 12 instead of tumbling. The ferrous 22 material will slide until the material has clumped together or clumped against one side of the next standard cleat 20. This clumping inhibits the ferrous 22 material from being able to tumble around such that the non-ferrous 26 materials cannot be shaken off. The non-ferrous 26 materials also get trapped in small crevices formed when adjacent pieces of ferrous 22 material clump together. Magnetic separation alone cannot effectively remove such non-ferrous 26 materials from the ferrous 22 material.

Non-ferrous 26 materials mixed together with ferrous 22 material after the sorting process causes a negative economic impact on the resale value of the sorted materials end product. If a portion of this end product has non-ferrous 26 materials within it, the resale value drops because the weight of the end product does not accurately reflect the amount of ferrous 22 material actually being sold. This typically reduces the resale value of the end product by around five dollars per ton.

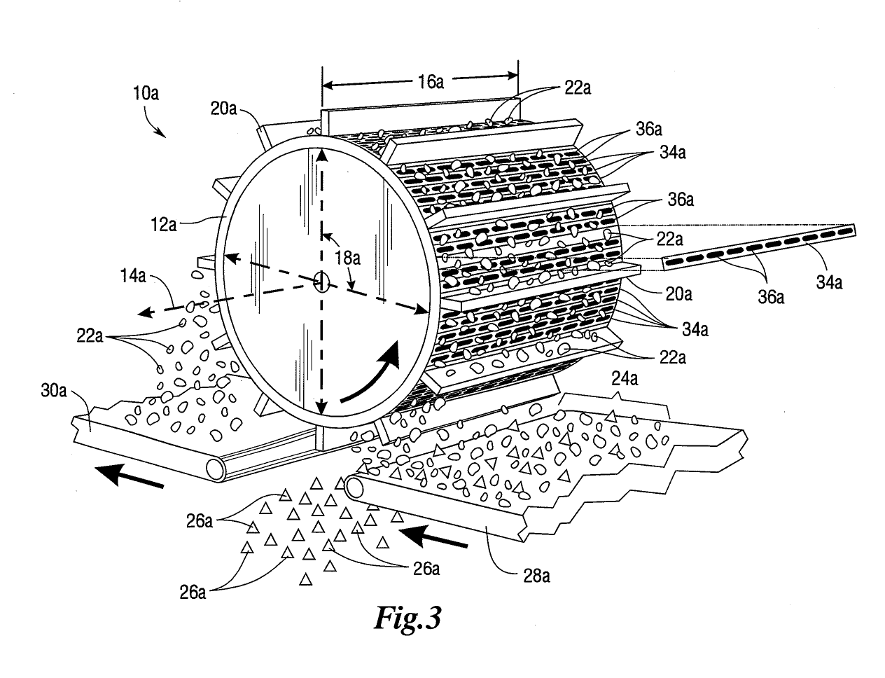

To alleviate the sorting problem and subsequent economic problem, in one embodiment, at least one traction plate 34a is joined to the surface of the outer shell 12a as shown in FIG. 3. Each traction plate 34a has a plurality of integral traction elements 36a on the outer surface of the traction plate 34a. These traction elements 36a on the traction plates 34a break up the smoothness of the surface of the outer shell 12a and prevent the ferrous 22a material from sliding along the surface of the outer shell 12a. Instead of sliding along the outer shell 12a, the edges of the ferrous 22a material catch on the rough uneven surface created by the traction elements 36a and force the ferrous 22a material to tumble on the outer shell 12a which will separate non-ferrous material 26a from the ferrous material 22a.

The traction elements 36a on the traction plates 34a also keep the ferrous 22a material from clumping together or clumping against one side of the next standard cleat 20a. Ferrous 22a material of different shapes and sizes will tumble on the surface of the outer shell 12a at different speeds and along different paths, in effect, causing the material to stagger and further spread out along the surface of the outer shell 12a. This staggering effect also further helps to separate ferrous 22a material from any trapped non-ferrous material 26a by giving the material more tumbling space and not clump together or clump against standard cleats 20a on the outer shell 12a.

The traction plates 34a are mounted onto and cover the surface of the outer shell 12a. The traction plates are sized to fit the tubular length 16a of the outer shell 12a, If the outer shell 12a has standard cleats 20a, the traction plates 34a mount onto the portions of the outer shell 12a that are between each standard cleat 20a. If the outer shell 12a does not have standard cleats 20a, the traction plates 36a could be made from a single component that completely wraps around the outer shell 12a. However, it does not matter whether the traction plates 34a are made from a single component or a plurality of components or if the entire surface of the outer shell 12a is covered, so long as enough of the surface of the outer shell 12a is covered that the ferrous 22a material tumbles and does not clump together.

The traction plates 34a are typically made from manganese steel, but stainless steel or any other material strong enough to withstand the long term use incorporated with the daily functions of magnetic drum separator 10a is sufficient. The traction plates 34a may also be releasably joined to the outer shell 12a so long as these plates can withstand the long term use incorporated with the daily functions of magnetic drum separator 10a as well.

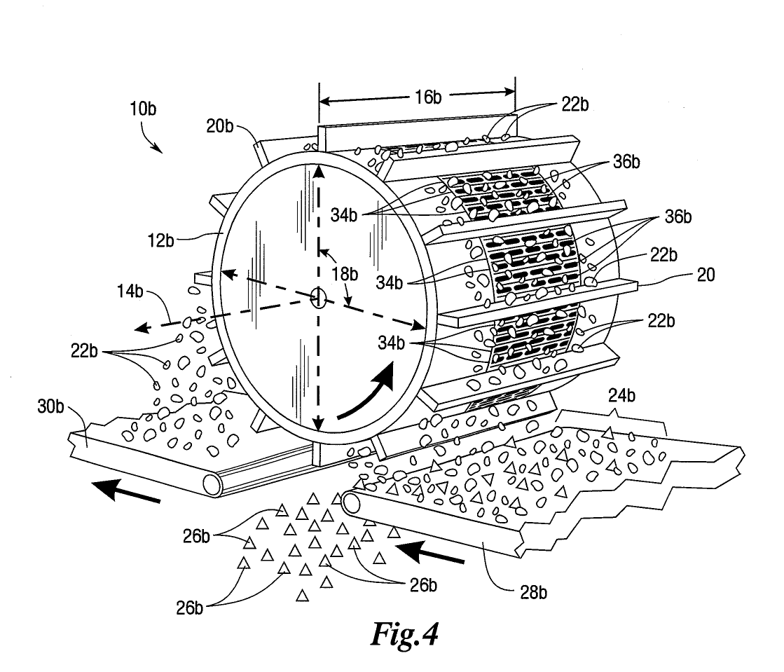

In another embodiment, as shown in FIG. 4, the traction plates 34b are not sized to fit the tubular length 16b of the outer shell 12b. Here the traction plates 34b are sized to fit a length that is shorter than the tubular length 16b of the outer shell 12b. In this embodiment, any length of the traction plates 34b that is shorter than the tubular length 16b of the outer shell 12b will suffice, so long as the traction plates 34b cover enough of the surface area of the outer shell 12b that the ferrous 22b material tumbles on the outer shell 12b and does not clump together.

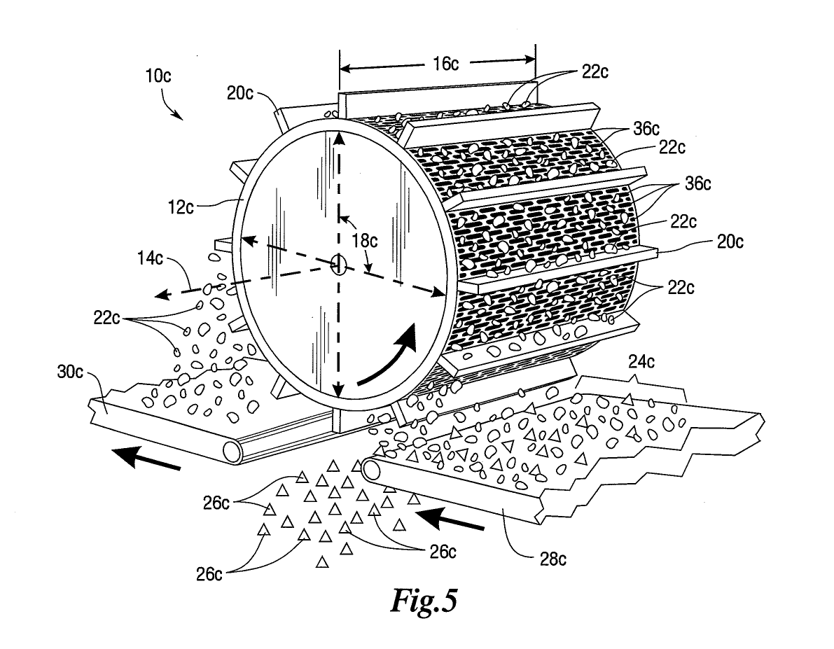

In another embodiment, as shown in FIG. 5, the outer shell 12c has a plurality of integral traction elements 36c. These traction elements 36c are embossed or impressed or both embossed and impressed directly on to the outer shell 12c. These traction elements 34c break up the smoothness of the surface of the outer shell 12c and prevent the ferrous 22c material from sliding along the surface of the outer shell 12c. Instead of sliding along the outer shell 12c, the edges of the ferrous 22c material catch on the rough uneven surface created by the traction elements 36c and force the ferrous 22c material to tumble on the outer shell 12c.

The traction elements also keep the ferrous 22c material from clumping together. Ferrous 22c material of different shapes and sizes will tumble on the surface of the outer shell 12c at different speeds and along different paths, in effect, causing the ferrous 22c material to stagger and further spread out along the surface of the outer shell 12c. This staggering effect also helps to further separate ferrous 22c material such that the ferrous 22c material will have more tumbling space and not clump together or clump against any standard cleats 20c on the outer shell 12c.

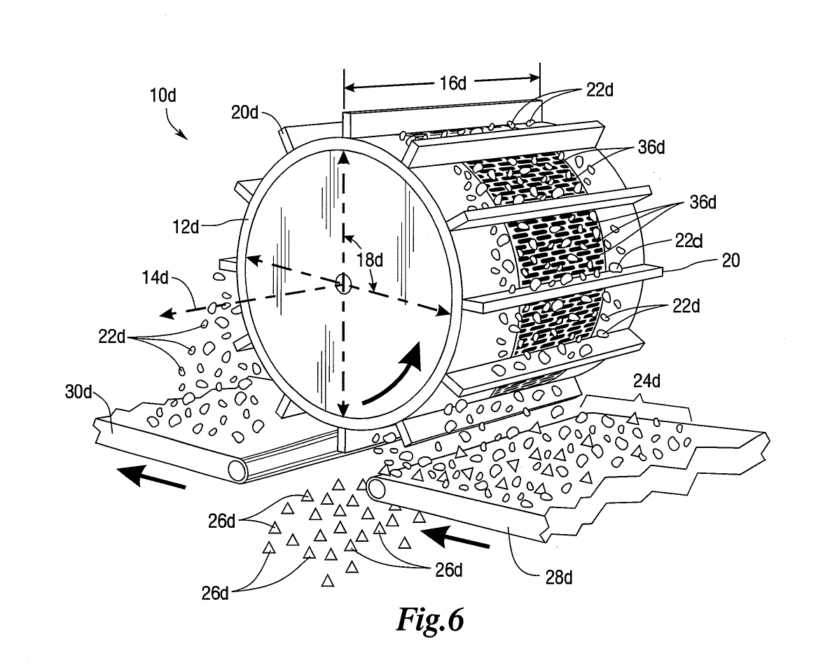

In another embodiment, as shown in FIG. 6, the integral traction elements 34d do not span the entire tubular length 16d of the outer shell 12d. Here, the integral traction elements 34d cover a length that is shorter than the tubular length 16d of the outer shell 12d. Any length of the integral traction elements 34d will suffice, so long as the traction elements 34d cover enough of the surface of the outer shell 12d that the ferrous 22d material will tumble and does not clump together.

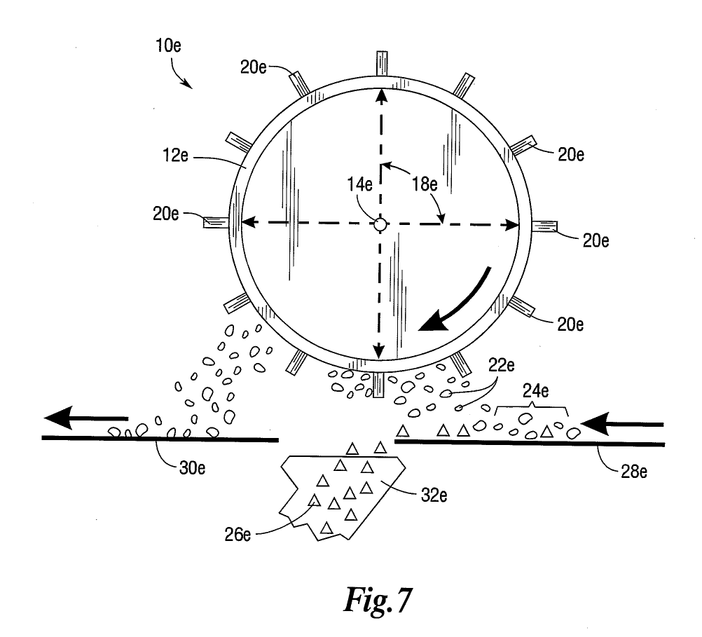

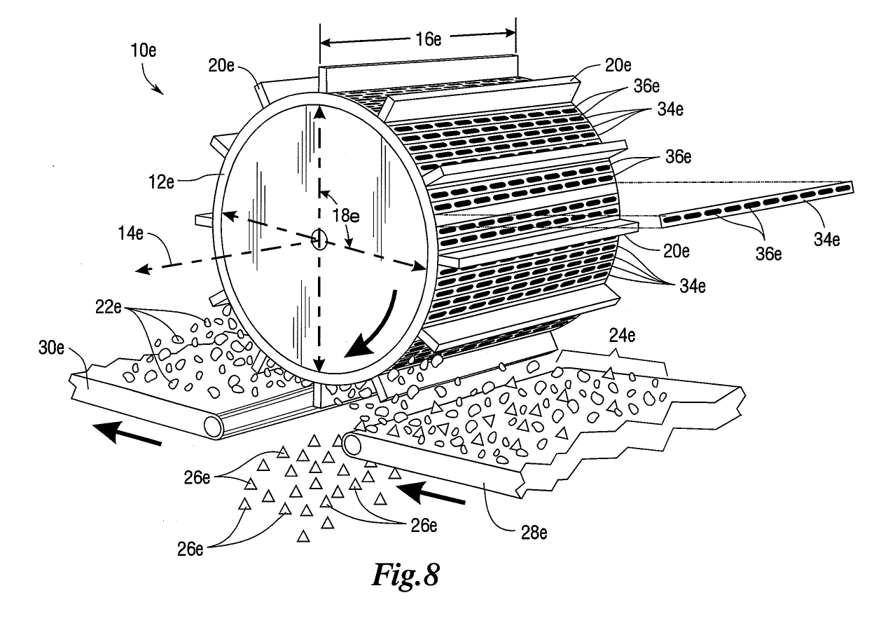

FIGS. 7 and 8 show a variation of the embodiments shown and described in FIGS. 2 and 3 above. In these embodiments, the rotation of the outer shell 12e is reversed. Ferrous 22e material is magnetically attracted to the drum separator 10e and becomes magnetically attached to the lower portion of the outer shell 12e. As the outer shell 12e rotates, the plurality traction elements 36e on the outer surface of the traction plate 34e, joined to the outer shell 12e, causes the magnetically attached ferrous 22e material to tumble (as discussed in greater detail above) while revolving around this lower portion of the magnetic drum separator 10e. Once the ferrous 22e material passes out of the magnetic field generated within the magnetic drum separator 10e, the ferrous 22e material will drop off the outer shell 12e, on the far side of the material steam 24e, and onto a second transfer system 30e. The non-ferrous 26e materials of the material stream 24e that is not attracted to the outer shell 12e should fall off the first transfer system 28e into a chute 32e or other means (not shown) for disposal or further processing. Non-ferrous 26e materials non-permanently attached to the ferrous 22e material (as discussed above) will also separate from of the ferrous 22e material by shaking off and falling directly into the chute 32e and will not fall back onto the first transfer system 28e.

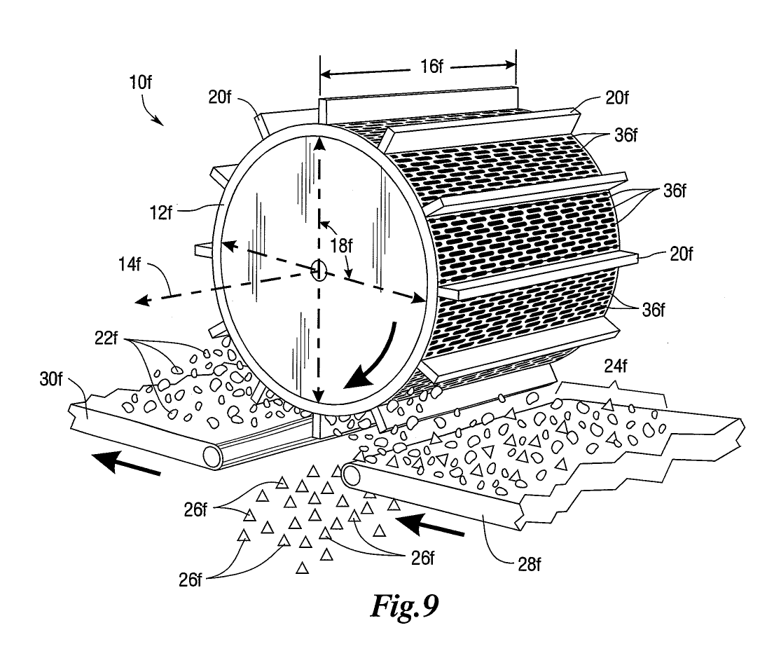

FIG. 9 shows a variation of the embodiment shown and described in FIG. 5. In this embodiment, the rotation of the outer shell 12f is reversed with the operation as discussed in greater detail above for FIGS. 7 and 8. In this embodiment, as the outer shell 12f rotates, a plurality of integral traction elements 36f embossed on the outer surface of the outer shell 12f causes the magnetically attached ferrous 22e material to tumble (as discussed in greater detail above) while revolving around this lower portion of the magnetic drum separator 10f. Once the ferrous 22f material passes out of the magnetic field generated within the magnetic drum separator 10f, the ferrous 22f material will drop off the outer shell 12f, on the far side of the material steam 24f, and onto a second transfer system 30f. The non-ferrous 26f materials of the material stream 24f that is not attracted to the outer shell 12f should fall off the first transfer system 28f into a chute 32f or other means (not shown) for disposal or further processing. Non-ferrous 26f materials non-permanently attached to the ferrous 22f material (as discussed above) will also separate from the ferrous 22f material by shaking off and falling directly into the chute 32f and will not fall back onto the first transfer system 28f.

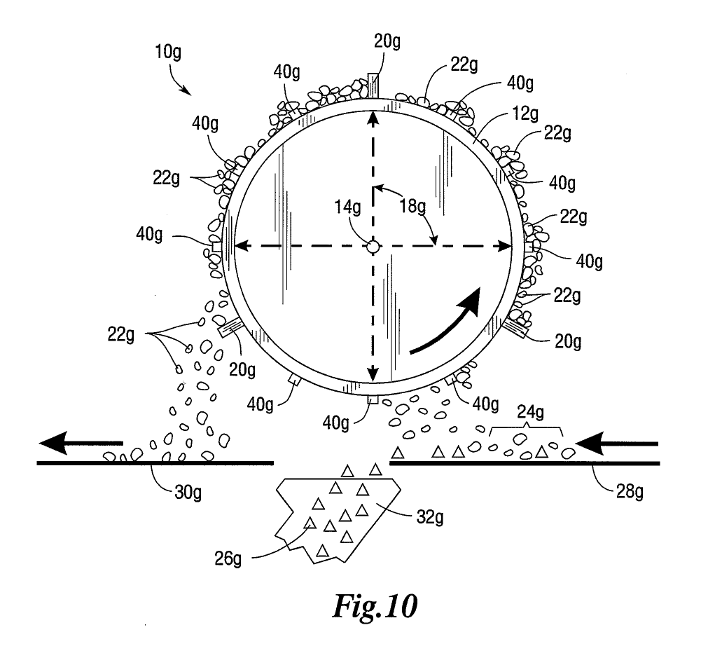

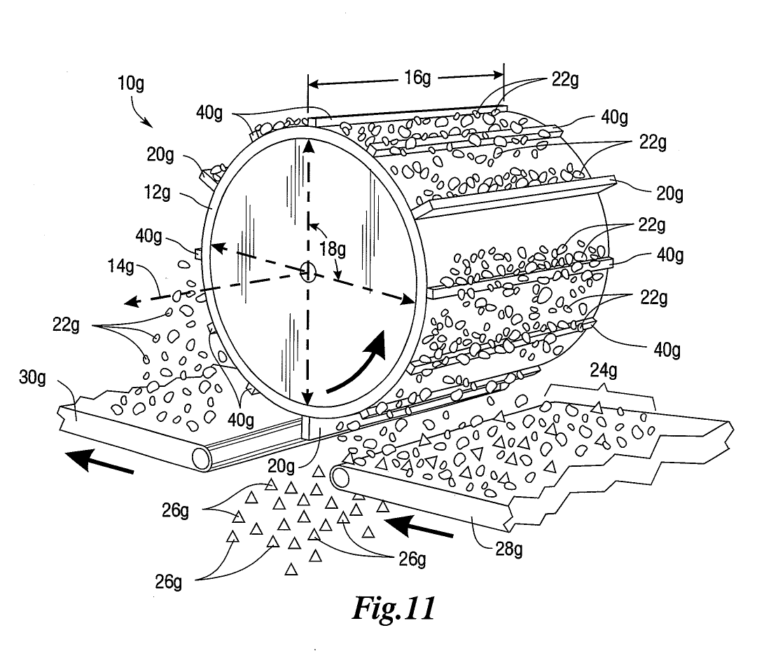

Traction elements 36 integral to the outer shell 12 and outer surface of traction plates 34 work well with smaller ferrous 22 material pieces, but not with certain kinds of larger ferrous 22 material pieces. To overcome this problem some embodiments of the magnetic drum separator 10g, as shown in FIGS. 10 and 11, incorporate minor cleats 40g that are particularly effective with the larger sized ferrous 22g material pieces unaffected by other embodiments of traction elements (as discussed above). Unlike standard cleats 20g that function, as in earlier embodiments, to ensure all magnetically attached ferrous 22g material revolves around the central axis 14g of the magnetic drum separator 10g, these minor cleats 40g function as traction elements in their own right. Instead of sliding along the outer shell 12g, the edges of the affected ferrous 22g material will catch on a minor cleat 40g and force the affected ferrous 22g material to tumble or roll or both tumble and roll over that minor cleat 40g.

These minor cleats 40g also keep the affected ferrous 22g material from clumping together or clumping against one side of the nearest standard cleat 20g (if any have been joined to the outer shell 12g). Ferrous 22g material of different shapes and sizes will tumble or roll or both tumble and roll over the minor cleats 40g at different speeds and along different paths, in effect, causing the ferrous 22g material to stagger and further spread out along the surface of the outer shell 12g. This staggering effect also further helps to separate ferrous 22g material such that the ferrous 22g material will have more tumbling space and not clump together or clump against any standard cleats 20g on the outer shell 12g.

In the embodiment shown in FIGS. 10 and 11, the outer shell 12g has a plurality of minor cleats 40g between standard cleats 20g. The minor cleats 40g are shorter in height than standard cleats 20g that must be tall enough to push the largest sized pieces of ferrous 22g material around the magnetic drum separator 10g. Typically the minor cleats 40g range from 0.5 inches to 2.5 inches in height after being joined to the outer shell 12g. One having ordinary skill in the art will see that any height of the minor cleats 40g may work so long as the minor cleats 40g cause ferrous 22g material to tumble or roll or both tumble and roll over the minor cleats 40g on the outer.

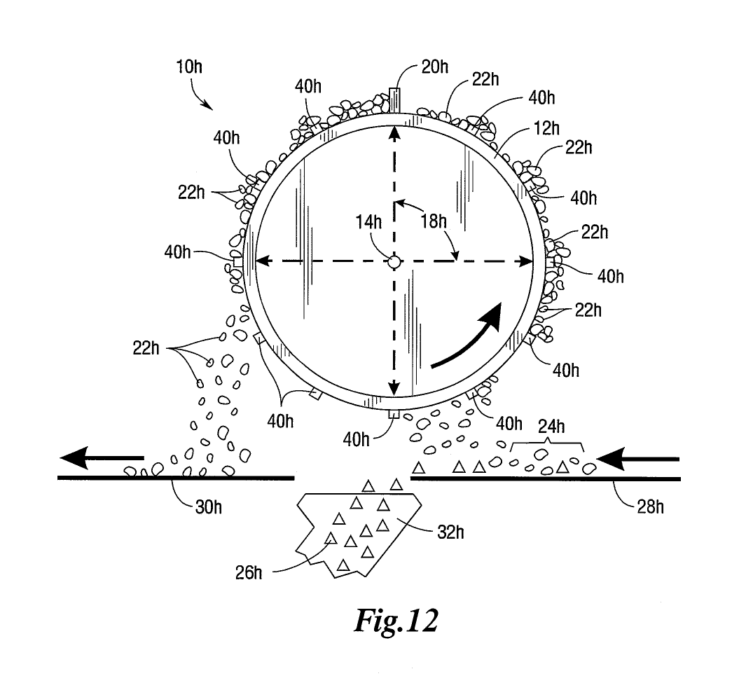

One of ordinary skill in the art will also understand that the number of standard cleats 20g can vary from as few as one to as many as are needed for the particular application of the magnetic drum separator 10g. For example, in the embodiment shown in FIG. 12, the outer shell 12h has a plurality of minor cleats 40h and a single standard cleat 20h. As discussed above, the minor cleats 40h are shorter in height than standard cleats 20h. Typically these minor cleats 40h are sized to fit the tubular length 16h of the outer shell 12h. In some instances the minor cleats 40h are sized to fit a length that is shorter than the tubular length 16h of the outer shell 12h. Sizing the minor cleats 40h to fit a length that is shorter than the tubular length 16h of the outer shell 12h can allow segmented configurations or staggered configurations or both configurations of the minor cleats 40h along the surface of the outer shell 12h. If the outer shell 12h has standard cleats 20h, the minor cleats 40h mount onto the portions of the outer shell 12h that are between each of these standard cleats 20h.

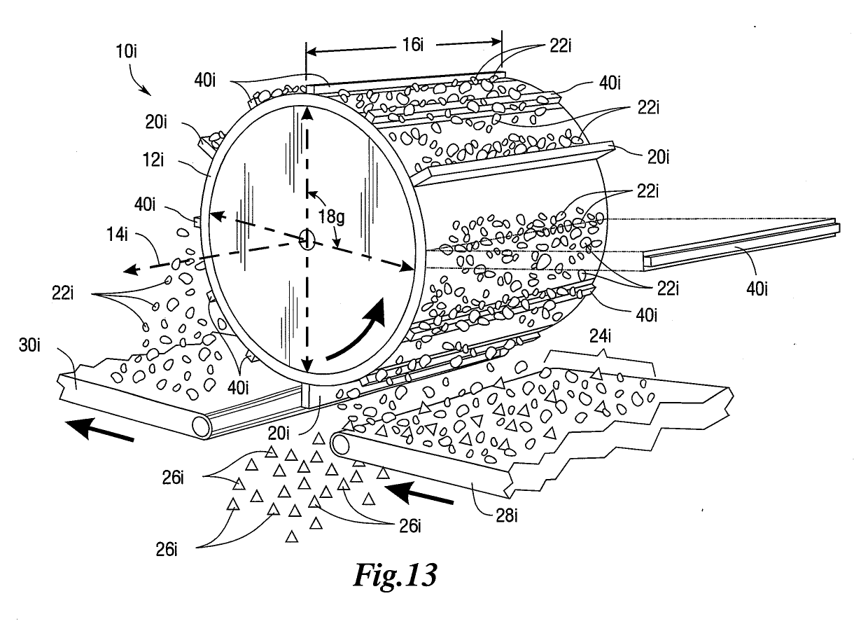

In other embodiments, the minor cleats 40i could be the traction elements 36i of the traction plates 34i. As shown in FIG. 13, each traction plate 34i has a single minor cleat 40i, integral to the outer surface of the traction plate 34i. These traction plates 34i having minor cleats 40i as traction elements are typically made from manganese steel, but stainless steel or any other material strong enough to withstand the long term use incorporated with the daily operations of magnetic drum separator 10i is sufficient. These traction plates 34i having minor cleats 40i as traction elements may also be releasably joined to the outer shell 12i so long as these plates can withstand the long term use incorporated with the daily operations of magnetic drum separator 10i.

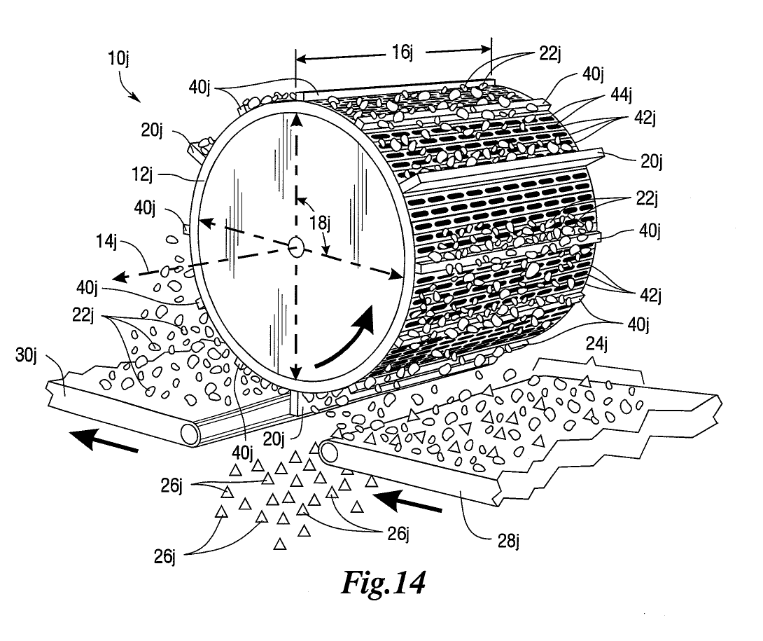

As shown in FIG. 14, it is also possible to combine different kinds of traction elements 36j on a single magnetic drum separator 10j. In this embodiment the separation process works with ferrous 22j materials that have a wide range of particulate sizes. The outer shell 12j has both a plurality of minor cleats 40j and additional traction plates 42j having additional traction elements 44j joined to the outer shell 12j. These additional traction plates 42j function to catch the edges of the ferrous 22j material too small to for the minor cleats 40j, while the minor cleats 40j work on material that will not catch on the traction elements 36j of the traction plates 34j.

The minor cleats 20j working in conjunction with the additional traction plates 42j to break up the smoothness of the surface of the outer shell 12j and prevent the ferrous 22j material from sliding along the surface of the outer shell 12j. Instead of sliding along the outer shell 12j, the edges of the ferrous 22j material catch on a minor cleat 40j or additional traction elements 44j on the additional traction plates 42j and force the ferrous 22j material to tumble or roll or both tumble and roll over that minor cleat 40j or additional traction elements 44j on the additional traction plates 42j or both.

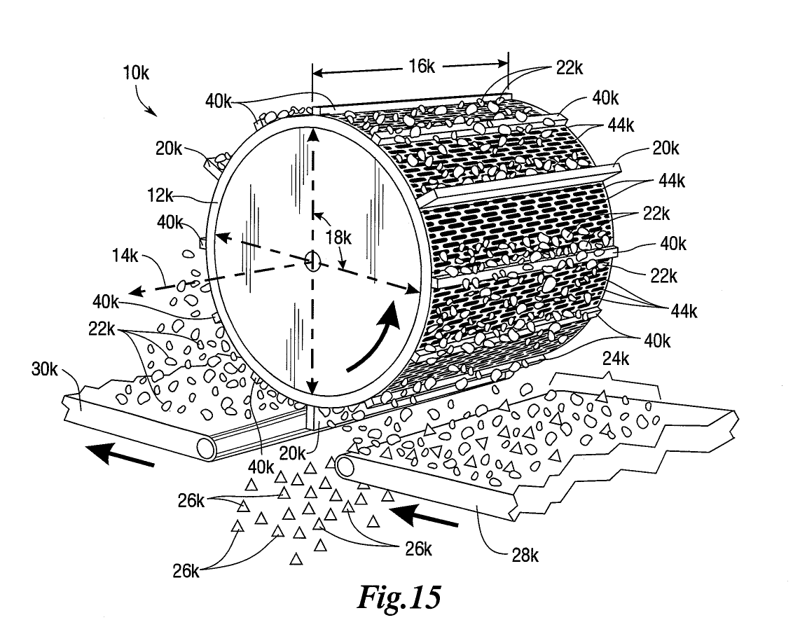

As shown in FIG. 15, in another embodiment, the outer shell 12k has both a plurality of minor cleats 40k joined to the outer shell 12k and additional traction elements 44k integral to the outer shell 12k. These additional traction elements 44k function to cause the edges of the ferrous 22k material, too small for the minor cleats 40k, to be used for traction purposes, to catch on the additional traction plates 42k and force such ferrous 22k material to tumble.

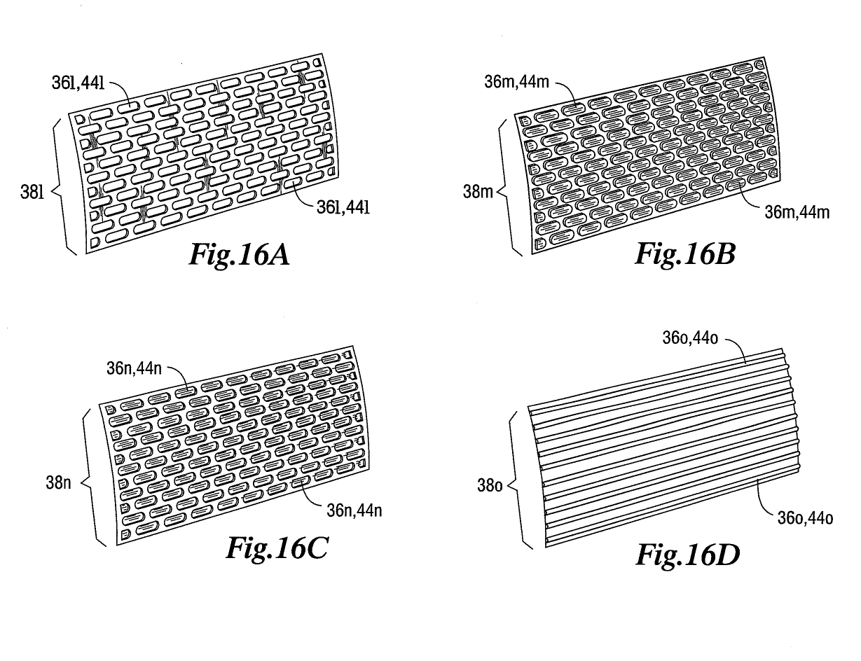

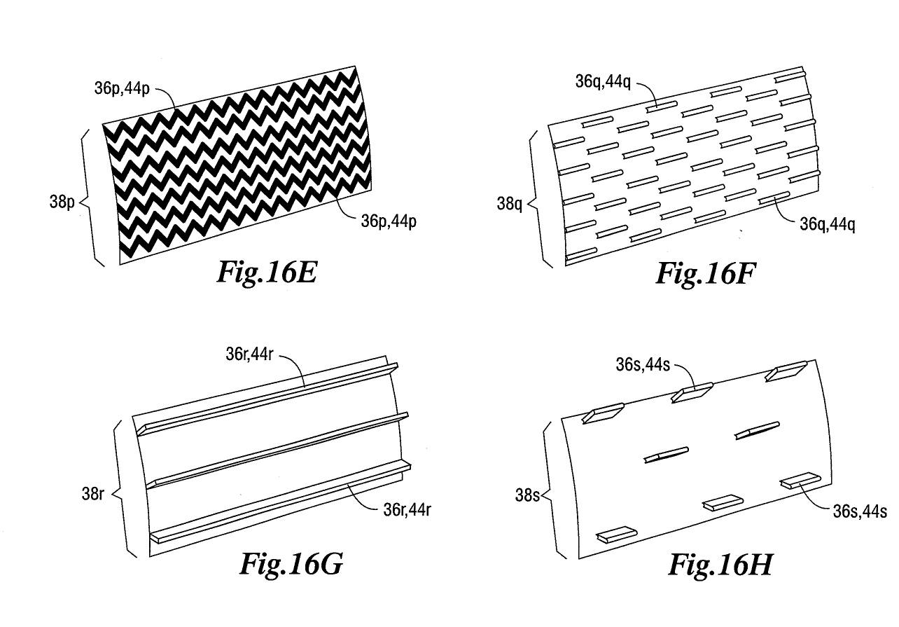

Comparing FIGS. 16A, through 16E, both the traction elements 361-s and additional traction elements 441-s can comprise various different geometric patterns 381-s embossed or impressed or both embossed and impressed into the traction plates (not shown) themselves or directly into the outer shell (not shown). The embodiment of the traction element 361/additional traction element 441 shown in FIG. 16A has a geometric pattern 381 that is a plurality of perforations cut entirely through the surface of the traction plate. FIG. 16B shows an embodiment of the traction element 36m/additional traction element 44m having a geometric pattern 38m that is a plurality of embossed or raised bumps that push up from the surface of the traction plate or outer shell as applicable. FIG. 16C, shows an embodiment of the traction element 36n/additional traction element 44n with a geometric pattern 38n that is a series of negative indentations or impressions that push into the surface of the traction plate or outer shell as applicable. FIG. 16D shows an embodiment of the traction element 36o/additional traction element 44o having a geometric pattern 38o that is a series of protruding ridges that raise up from the surface of the traction plate or outer shell as applicable. FIG. 16E shows the embodiment of the traction element 36p/additional traction element 44p having a geometric pattern 38p that is a series of serrated teeth protruding from the surface of the traction plate or outer shell as applicable. FIG. 16F shows an embodiment of the traction element 36q/additional traction element 44q having a geometric pattern 38q that is a series of protruding ridges that are segmented into equal portions, creating a staggered pattern raised up from the surface of the traction plate or outer shell as applicable. FIG. 16G shows the embodiment of the traction element 36r/additional traction element 44r having a geometric pattern 38r that is a series of minor cleats that raise up from the surface of the traction plate traction element is arranged in an angled manner near the outer edges of the tubular length of said outer shell or outer shell as applicable. FIG. 16H shows the embodiment of the traction element 36s/additional traction elements 44s having a geometric pattern 38q that is a series of minor cleats that are segmented into equal portions, creating a staggered pattern raised up from the surface of the traction plate or outer shell as applicable. It should be obvious to one having ordinary skill in the art that the embodiments of traction elements and additional traction elements 441-s are not limited to the geometric patterns 361-s as described herein.

The outer shell of the magnetic drum separator could comprise a variety of traction plates each having their own geometric pattern of traction elements/additional traction elements on the traction plate. The outer shell of the magnetic drum separator could also comprise traction plates with traction elements/additional traction elements having a variety of different geometric patterns on the traction plate. If the outer shell has integral traction elements/additional traction elements on the outer surface of the outer shell, the outer shell could comprise a variety of geometric patterns of these integral traction elements/additional traction elements. As such, different variations of geometric patterns of traction elements/additional traction elements can be strategically located along the outer shell so as to allow for a more even spread of ferrous material along the outer shell as the outer shell rotates.

The geometric patterns of traction elements/additional traction elements can also be strategically arranged, or positioned, along the outer shell so as to manipulate the flow of ferrous material while spreading out along the outer shell as the outer shell rotates. In one such example, magnetic drum separators comprising either electromagnets or permanent magnets will often times produce “dead zones” of weakened magnetic field strength along each of the outer edges of the tubular length of the outer shell. These “dead zones” create what is known as an edge effect, wherein all of the ferrous material ends up clumping towards the center of the tubular length of the outer shell, which ultimately leads to the under-utilization of the surface area of the outer shell.

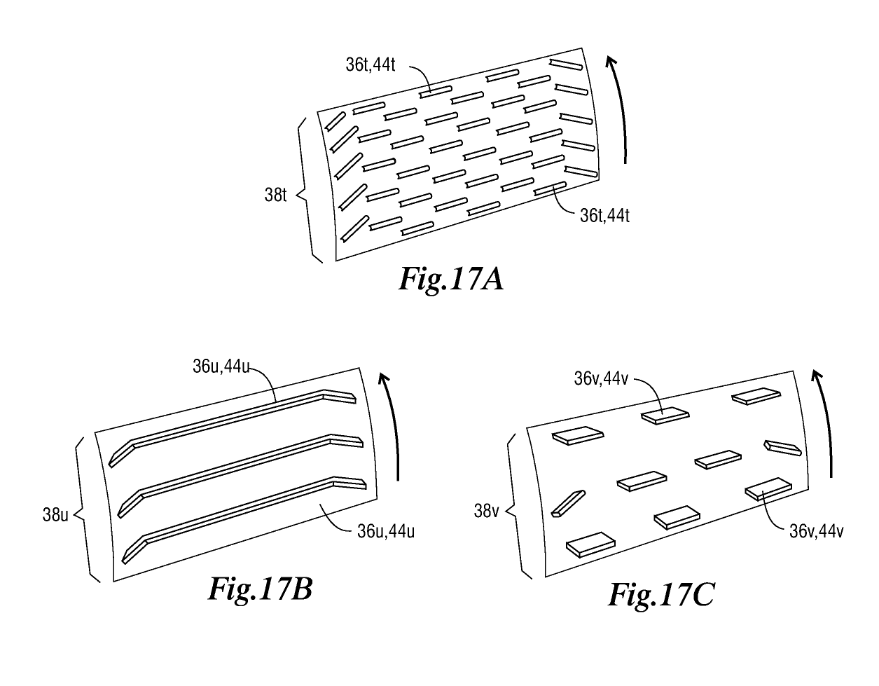

As shown in FIGS. 17A, to mitigate this edge effect, a variation of geometric patterns 38t of traction elements 36t/additional traction elements 44t can be strategically arranged in an angled, or biased, manner near the outer edges of the tubular length of the outer shell and away from the direction of rotation, to facilitate the spreading of the ferrous material out towards the edges of the outer shell. Spreading the ferrous material outward and into these dead zones, reduces the under-utilization of the surface area of the outer shell from ferrous material clumping together towards the center of the tubular length of the outer shell. It should be understood that arranging the traction elements 36t/additional traction elements 44t in an angled manner usually begins within 2 feet from each of the outer edges of the tubular length of the outer shell.

However, one having ordinary skill in the art will see that arranging the traction elements 36t/additional traction elements 44t in an angled manner can begin anywhere along the tubular length of the outer shell, so long as ferrous material spreads into the dead zones, and does not clump together towards the center of the tubular length of the outer shell.

In FIG. 17A, traction elements 36t/additional traction elements 44t are a series of protruding ridges with the ridges close to the outer edges angled as shown. FIG. 17B shows a variation of traction elements 36u/additional traction elements 44u that are minor cleats with the cleats to the outer edges angled as shown. FIG. 17C shows a variation of traction elements 36v/additional traction elements 44v that are a series of minor cleats that are segmented into equal portions, creating a staggered pattern with the cleats to the outer edges angled as shown. It should be obvious to one having ordinary skill in the art that the embodiments of traction elements 36t-v/additional traction elements 44t-v are not limited to the geometric patterns 36t-v as described herein.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A magnetic drum separator for the separation of ferrous and non-ferrous materials from a material stream comprising:
an outer shell that is rotatable by a drive mechanism;
said outer shell having a tubular length and a circular cross-section;
a traction plate joined to said outer shell; and
said traction plate having a traction element.

2. The magnetic drum separator of claim 1 wherein said traction plate is made from stainless steel or manganese steel.

3. The magnetic drum separator of claim 1 wherein said traction plate is sized to fit said tubular length of said outer shell.

4. The magnetic drum separator of claim 1 wherein said traction plate is releasably joined to said outer shell.

5. The magnetic drum separator of claim 1 wherein said traction element is a minor cleat.

6. The magnetic drum separator of claim 1 wherein said traction element is arranged in an angled manner near the outer edges of the tubular length of said outer shell.

7. The magnetic drum separator of claim 1 wherein said traction element is a series of negative indentations, raised bumps, perforations, serrated teeth, protruding ridges, segmented protruding ridges, minor cleats, or segmented minor cleats.

8. The magnetic drum separator of claim 1 further comprising a standard cleat joined to said outer shell.

9. The magnetic drum separator of claim 1 further comprising:
at least two traction plates joined to said outer shell; and
one of said at least two traction plates having a traction element that is a minor cleat.

10. A magnetic drum separator for the separation of ferrous and non-ferrous materials from a material stream comprising:
an outer shell that is rotatable by a drive mechanism;
said outer shell having a tubular length and a circular cross-section; and
said outer shell having an integral traction element.

11. The magnetic drum separator of claim 10 wherein said outer shell is made from stainless steel or manganese steel.

12. The magnetic drum separator of claim 10 wherein said outer shell having said traction element span across said tubular length of said outer shell.

13. The magnetic drum separator of claim 10 wherein said integral traction element is a minor cleat.

14. The magnetic drum separator of claim 10 wherein said traction element is arranged in an angled manner near the outer edges of the tubular length of said outer shell.

15. The magnetic drum separator of claim 10 wherein said integral traction element is a series of negative indentations, raised bumps, perforations, serrated teeth, protruding ridges, segmented protruding ridges, minor cleats, or segmented minor cleats.

16. The magnetic drum separator of claim 10 further comprising a standard cleat joined to said outer shell.

17. The magnetic drum separator of claim 10 further comprising:
a traction plate joined to said outer shell; and
said traction plate having a traction element.

18. The magnetic drum separator of claim 10 further comprising:
a traction plate joined to said outer shell; and
said traction plate having a traction element that is a minor cleat.

19. A magnetic drum separator for the separation of ferrous and non-ferrous materials from a material stream comprising:
an outer shell that is rotatable by a drive mechanism;
said outer shell having a tubular length and a circular cross-section; and
said outer shell having a traction means for causing the material stream to tumble on said outer shell to separate the ferrous material from the non-ferrous material.

20. The magnetic drum separator of claim 19 further comprising a standard cleat joined to said outer shell.
